(19) United States
(12) Patent Application Publication
(10) Pub. No.: US 2011/0098030 A1
(43) Pub. Date: Apr. 28, 2011

(54) METHOD AND APPARATUS FOR ACTIVATING SERVICES

(75) Inventor: Kristian Luoma, Kiviniemi (FI)

(73) Assignee: Nokia Corporation, Espoo (FI)

(21) Appl. No.: 12/607,034

(22) Filed: Oct. 27, 2009

(51) Int. Cl. H04W 60/00; H04M 3/00

(52) U.S. Cl. 455/419; 455/435.1; 455/466

(57) ABSTRACT

An approach is provided for activating a service for a mobile device. A message is received from a mobile device specifying a unique hardware identifier associated with the mobile device for activating a service for the mobile device. Creation of a provisional account is caused, at least in part, to be created to activate the service based on the unique hardware identifier without user information.

### BACKGROUND

Service providers (e.g., wireless, cellular, etc.) and device manufacturers are continually challenged to deliver value and convenience to consumers by, for example, providing compelling network services. However, these services, in general, require users to proactively take steps for activation. Also, many activation schemes require a plethora of information from the user, further deterring the users from activating the services. Thus, traditional activation schemes are largely cumbersome, confusing, time consuming, and manually intensive. Consequently, many consumers may opt to forgo the service rather than be subjected to the complex, intrusive activation process. That is, the many services that are available to consumers may not even be activated.

### SOME EXAMPLE EMBODIMENTS

Therefore, there is a need for an automated, user friendly approach to activating a service.

According to one embodiment, a method comprises receiving a message from a mobile device specifying a unique hardware identifier associated with the mobile device for activating a service for the mobile device. The method also comprises causing, at least in part, creation of a provisional account to activate the service based on the unique hardware identifier without user information.

According to another embodiment, an apparatus comprising at least one processor, and at least one memory including computer program code, the at least one memory and the computer program code configured to, with the at least one processor, cause, at least in part, the apparatus to receive a message from a mobile device specifying a unique hardware identifier associated with the mobile device for activating a service for the mobile device. The apparatus is also caused to cause, at least in part, creation of a provisional account to activate the service based on the unique hardware identifier without user information.

According to another embodiment, a computer-readable storage medium carrying one or more sequences of one or more instructions which, when executed by one or more processors, cause, at least in part, an apparatus to receive a message from a mobile device specifying a unique hardware identifier associated with the mobile device for activating a service for the mobile device. The apparatus is also caused to cause, at least in part, creation of a provisional account to activate the service based on the unique hardware identifier without user information.

According to another embodiment, an apparatus comprises means for receiving a message from a mobile device specifying a unique hardware identifier associated with the mobile device for activating a service for the mobile device. The apparatus also comprises means for causing, at least in part, creation of a provisional account to activate the service based on the unique hardware identifier without user information.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of conveniently activating a service, according to one embodiment;

FIG. 2 is a diagram of the components of an activation platform, according to one embodiment;

FIG. 3 is a flowchart of a process for provisionally activating a service tied to a user equipment, according to one embodiment;

FIG. 4 is a flowchart of a process for completing activation of a service that has been provisionally activated, according to one embodiment;

FIG. 5 is a flowchart of a process for initiating activation of a service tied to a user equipment, according to one embodiment;

FIG. 6 is a ladder diagram presenting processes for conveniently activating a service by a user, according to one embodiment;

FIG. 7 is a diagram of a user interface utilized in the processes of FIGS. 3-6, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for conveniently activating a service are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

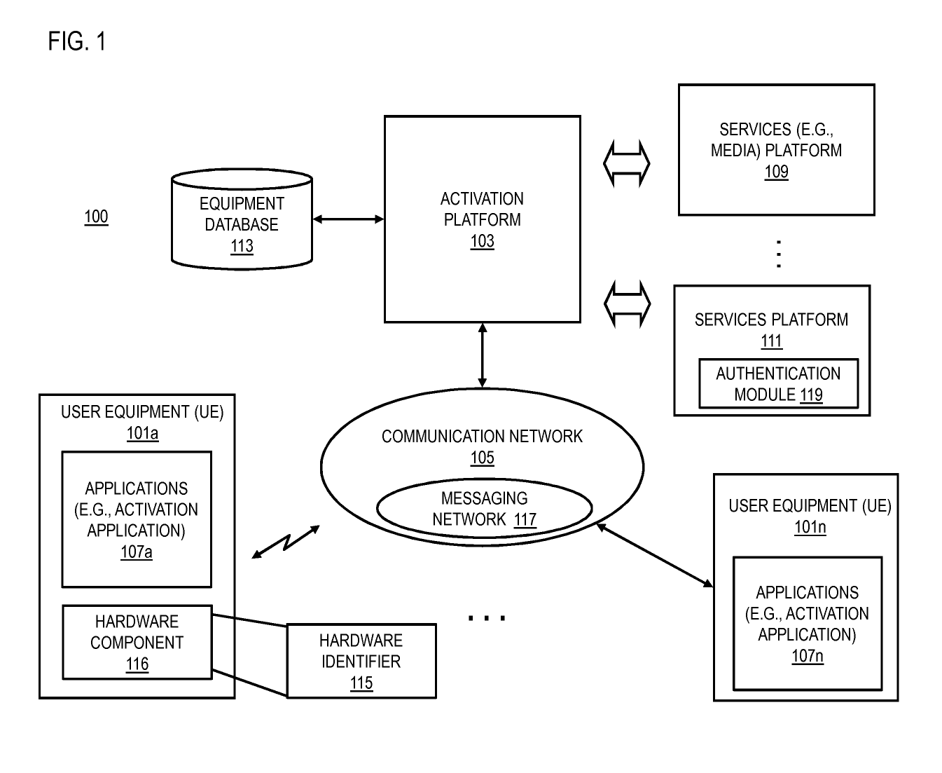

FIG. 1 is a diagram of a system 100 capable of improving the activation process of services, according to one embodiment. Network services, such as media services (e.g., music services, video services, photo services, etc.), navigation services, gaming services and the like are increasingly being offered to users who can engage in these services using their user equipment. Although various embodiments are described with respect to media services, it is contemplated that the approach described herein may be used with other services. Some of these services require activation before a user is able utilize the respective service. As mentioned, conventionally, activation includes collecting a variety of information from the user, such as the user's name, age, contact information, user name, password, etc. This activation process may be time consuming or complex, thereby resulting in users not partaking or otherwise subscribing to the services. It is noted that service providers may have invested heavily in the development of such services; the return on this investment can be undermined if users are reluctant to even try the service because of a cumbersome activation procedure.

To address this problem, the system 100 of FIG. 1 introduces the capability to conveniently activate a service. According to certain embodiments, users can activate a service using their user equipment (UE) 101a-101n, which interact with an activation platform 103 over a communication network 105. Each of the UEs 101a-101n may use one or more applications 107a-107n to activate (e.g., activation application 107) and/or utilize (e.g., a media application 107) the media service. The media service is provided by media platform 109. Additionally, the UEs 101a-101n may access other services, as provided by one or more other services platforms 111 (of which one is shown). As shown, the activation platform 103 communicates with an equipment database 113, which stores information about the user equipment that qualify to activate the services of platforms 109 and 111.

According to certain embodiments, the activation application 107 may be executed during an initialization process of the UE 101, such as when the UE 101 is first powered up or when the UE 101 receives access to the communication network 105. Additionally or alternatively, the activation application 107 may be executed when the UE 101 receives input to use a service for the first time.

To provide automated activation of services, the activation platform 103 determines those UEs that are permitted to activate such services by using unique hardware identifiers. The UE 101 may include one or more hardware identifiers 115 for uniquely identifying the UE 101. The hardware identifiers 115 may be identification data that can be stored in memory of the UE 101 or can be a serial number or other unique identifier that can be obtained from a hardware component 116 of the UE 101. Such a hardware identifier 115 can include user accessible identifiers such as an International Mobile Equipment Identity (IMEI), an electronic serial number, Mobile Equipment Identity (MEID), user inaccessible identifiers such as a serial number of a component (e.g., a processor, transceiver, etc.) associated with the UE 101 or another identifier known to the manufacturer of the UE 101, or other identifiers unique to a particular UE 101. Moreover, in certain embodiments, the hardware identifier 115 may be a removable hardware identifier located on a removable memory device such as a subscriber identity module (SIM) or on a removable component attached to the UE 101 (e.g., a BLUETOOTH headset or a hands free communication device) that the UE 101 may extract the hardware identifier 115 from. In these embodiments, the UE may initiate the automated activation services in response to the first connection with the removable memory device or removable component. The removable memory device or removable component may have an identifier indicating to the activation application 107 that it may have services associated with it that can be activated. Information about these identifiers may be included in the equipment database 113.

The activation application 107 can retrieve and transmit one or more hardware identifiers 115 to the activation platform 103 via the communication network 105 as part of the automated activation procedure. The activation application 107 may be configured to access to the activation platform 103 using an identifier of the activation platform 103 (e.g., telephone number, website address, etc.). Once activation is completed by the activation platform 103, the UE 101 receives a message notifying the user of the status of the activation. Upon successful activation, the user may utilize the UE 101 to access the service.

In effect, in certain embodiments, the activation platform 103 creates a provisional account based on one or more hardware identifiers 115 associated with the UE 101. In the scenarios whereby the hardware identifier 115 is associated with a removable component or removable memory device, the account may be associated with the removable component or the removable memory device in place of the UE 101. In certain embodiments, examples are provided that indicate that hardware identifiers 115, accounts, licensing, etc. are tied or associated with a UE 101; however, it is contemplated that the accounts, hardware identifiers, and/or licensing may also be tied to the removable component or removable memory device. The activation application 107 may be used to determine the hardware identifier 115 from the removable devices. Provisional account information can be stored in a database (not shown) that can be accessed by the media platform 109 or other services platforms 111. For example, media services may require appropriate licensing information to be authenticated and processed. As such, the activation platform 103 may then activate, for example, the media service based on the licensing status of the UE 101.

To assist with managing the user accounts and services, the activation platform 103 can utilize the equipment database 113 to store relevant information about the UEs (e.g., UE 101a). In one embodiment, the UE information can include hardware identifiers 115 that can be associated with other information about a corresponding UE 101. The other information corresponding to the hardware identifiers 115 can include licensing information that provides the type of service access and time period of access the UE 101 is entitled to. Also, some of the licensing information may be based on other characteristics of the UE 101 such as the country location of the UE 101. This may be important because many countries have different copyright, trademark, and other licensing laws and the UE 101 used in one country may have different rights than a UE 101 used in another country. Further, the service provider and user may have access to different content in different countries based on contracts made by the service provider with other entities. Additionally, the equipment database 113 may store a “blacklist” status of UEs 101. A UE 101 may be marked as blacklisted if the UE 101 is not permitted access to the service for one or more reasons, e.g., country restrictions.

The services platform 111 may begin providing access to the service by users who have established provisional accounts. The UEs 101 of the users may authenticate with the services platform 111 by providing information of the hardware identifier(s) 115 corresponding to each UE 101. According to one embodiment, an activation notification message is transmitted back to the UE 101 to acknowledge the establishment of the provisional account and to provide information for converting this provisional account to a full account. With the full account, the user can access the service through other equipment.

Services platforms 111 may include services such as location services (e.g., navigation, mapping, etc.), media services (e.g., music, video, images, etc.), information services (e.g., news, sports, etc.), or the like. An exemplary services platform 111 is that of media platform 109. These services may require some authentication and/or licensing. An authentication module 119 may be used to determine if a UE 101 or user has privileges to use the service. Some of the privileges may be attached to the UE 101. For example, some of the privileges to use the services may be based on a brand and type of UE 101, which can be sold packaged with access to the service. Access to the service may be activated by the UE 101 automatically once the UE 101 has access to a messaging network 117 (which, as shown, can be a part of the communication network 105) or when the user first attempts to access the service. When the user first attempts to access the service, a message is sent to an activation platform 103.

By way of example, the communication network 105 of system 100 includes one or more networks such as a data network (not shown), a wireless network (not shown), a telephony network (not shown), a messaging network 117, or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like. Moreover, the messaging network 117 can provide, according to certain embodiments, services such as email, instant messaging (IM), SMS messaging (e.g., text messaging), MMS messaging, or other messaging communication.

As noted, the messaging network 117 can provide for SMS messaging and/or MMS messaging capabilities. The messaging network 117 may be a part of a telephony network (e.g., a cellular network). As part of a cellular network, UE 101 can communicate with a cellular tower to send and receive data including SMS messaging and MMS messaging. Cellular towers communicate with a UE 101 via control channels so that the UE 101 is able to ascertain which cellular tower to connect to. A control channel can also be utilized to deliver messages. A message can be sent to a UE 101 via a cellular tower and a MSC. The MSC can be used as a medium between the cellular network and internet protocol networks designed to carry messaging traffic. The message can have information about the message and the destination such as the length of the message, a time stamp, the destination phone number, etc., which can be used to route the message to the destination. In one example, activation platform 103 can send a message to the UE 101 via the messaging network 117 by sending the message to the MSC via an internet protocol network. Then, the MSC can deliver the message to the UE 101 via the cellular tower control channel.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, activation platform 103, media platform 109, and services platforms 111 communicate with each other and other components of the communication network 105 using well known, new or still developing protocols. In this context, a protocol includes a set of rules defining how the network nodes within the communication network 105 interact with each other based on information sent over the communication links The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

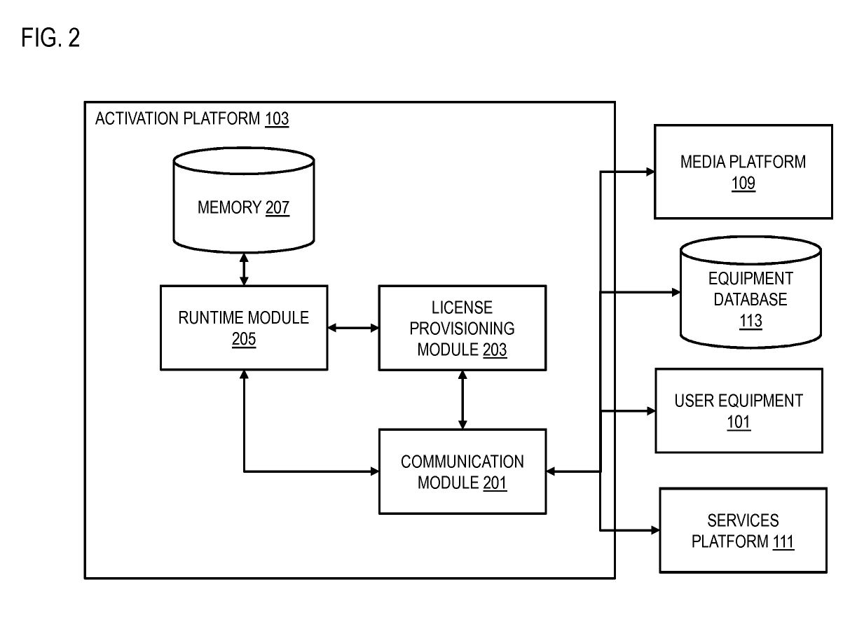

FIG. 2 is a diagram of the components of the activation platform 103, according to one embodiment. By way of example, the activation platform 103 includes one or more components for providing an activation process without user information. It is contemplated that the functions of these components may be combined in one or more components or performed by other components of equivalent functionality. In this embodiment, the activation platform 103 includes a communication module 201 to communicate with other devices, a license provisioning module 203 to determine licenses for a UE 101, a runtime module 205 to control activation services, and a memory 207 to store data.

In one embodiment, the activation platform 103 includes a communication module 201. The communication module 201 can be used to communicate with a UE 101, services platforms 111, a media platform 109, an equipment database 113, and other devices available through a communication network 105. Certain communications can be via methods such as an internet protocol, messaging, or any other communication method (e.g., via the communication network 105). In some examples, the activation platform 103 can send/receive messages to/from a UE 101 via the communication module 201. Moreover, the activation platform 103 may communicate with services platforms 111 and media platforms 109. Such communications may include, among other data, transfer of information relating to account information, UE 101 information, activation information, or the like.

The activation platform 103 may also include a license provisioning module 203. The license provisioning module 203 may receive a hardware identifier 115 associated with a UE 101 and a request for activating a service. Then, the license provisioning module 203 can retrieve information associated with the hardware identifier 115 from an equipment database 113. The equipment database 113 can be updated by the activation platform 103 as well as other platforms such as the services platforms 111, media platform 109, or a platform associated with a manufacturer of the UE 101. The equipment database 113 can include a “blacklist” status of the UE 101. As previously noted, the blacklist status may be a designation as to whether the UE 101 has been listed as not permitted to activate the service for one or more reasons. Exemplary reasons for a UE 101 to be blacklisted include that the UE 101 was reported stolen, complaints about the UE 101 or a user of the UE 101, and/or violations of the terms of use of one or more services. The license provisioning module 203 may also retrieve additional information about the UE 101 such as licensing information from the equipment database 113. Licensing information can include types of services associated with the UE 101 as well as the type of licenses available (e.g., buy as you go, monthly rental, unlimited use for a period of time, unlimited downloading of content for a period of time and unlimited use of the content on the UE 101, etc.) to the UE 101 and/or license expiration information. The license provisioning module 203 can also determine a country associated with the UE 101 by receiving an identifier (e.g., via a phone number, network identifier, etc.) associated with the UE 101. The country that the UE 101 is associated with could affect the licensing information (e.g., some license types are unavailable in certain countries). Further, the licensing module 203 may detect whether a portion of a license associated with the UE 101 has been used (e.g., if an account was activated and then deactivated because the UE 101 was activated by one user and then sold to a new user). In this scenario, the unused license time may be utilized to activate the provisional account. Then, the license provisioning module 203 can determine a type of provisional account that can be activated for the UE 101 and generate provisional account information. The license provisioning module 203 may then use the communication module 201 to notify the services platform 111 of the provisional account information. In certain embodiments, the procedures of the license provisioning module 203 can be accomplished by the services platform 111 or media platform 109.

A runtime module 205 of the activation platform 103 may be utilized to control the activation process. The runtime module 205 can receive a message from a UE 101 to activate a particular service associated with the UE 101. Then, the runtime module 205 may use the license provisioning module 203 to generate provisional account information that may be used by the UE 101 to authenticate with the service. The provisional account information may include a license status of the UE 101 that specifies what service access the UE 101 is provisioned. The provisional account information may also include the hardware identifier 115 that can be used to authenticate the UE 101. Moreover, the provisional account information may also contain information that can be used to convert the provisional account to a full account. This information can include an activation code that can be used by a user of the UE 101 on another device. Once the provisional account information is generated, the runtime module 205 may send a message to the UE 101 via the communication module 201 notifying the UE 101 of the activation of the provisional account. The message may also include the activation code to convert the provisional account tied to the UE 101 into a full account that may be tied to a user.

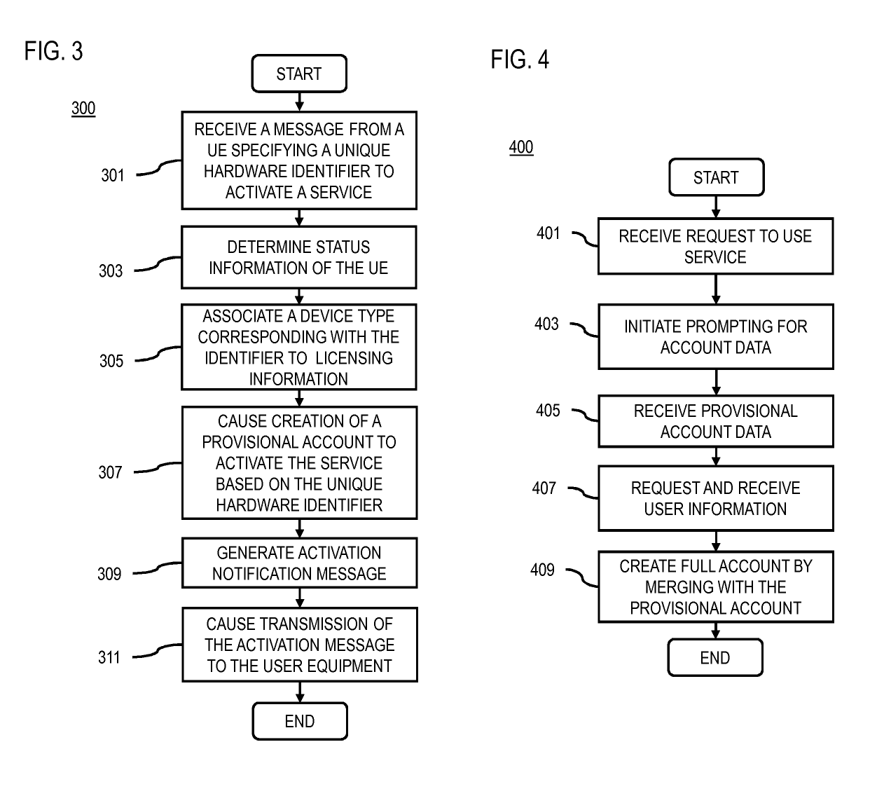

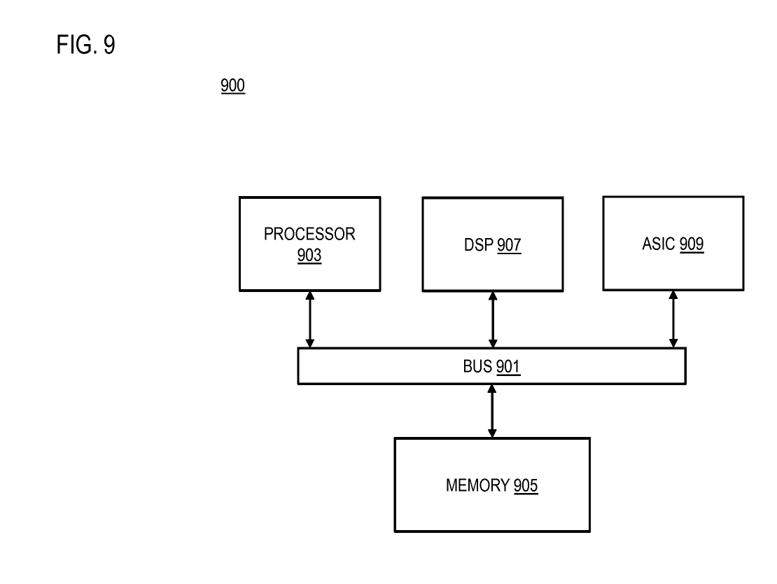

FIG. 3 is a flowchart of a process for provisionally activating a service tied to a user equipment 101, according to one embodiment. In one embodiment, the runtime module 205 performs the process 300 and is implemented in, for instance, a chip set including a processor and a memory as shown FIG. 9. In certain embodiments, the runtime module 205 is part of an activation platform 103, in other embodiments, the actions of the runtime module 205 may be implemented on a services platform 111 such as a media platform 109. For example, UE 101a, via the activation application 107a may initiate sending of a message to an activation platform 103 specifying a hardware identifier 115 of the UE 101a to activate a particular service.

In step 301, the runtime module 205 of the activation platform 103 receives a message (e.g., an SMS, MMS, etc.) from a UE 101 (e.g., a mobile device) specifying a unique hardware identifier 115 associated with the UE 101 for activating the service. Additionally, the message may include other information such as a Mobile Country Code (MCC), a Mobile Network Code (MNC), a Mobile Subscriber Integrated Services Digital Network Number (MSISDN), or other information associated with the UE 101. Moreover, the message may include a request to activate one or more services. Alternatively or additionally, the message may be sent to a particular identified location of the activation platform 103 that is associated with a particular type of service. The runtime module 205 can receive the message via a communication module 201 of the activation platform 103.

Then, at step 303, the runtime module 205 determines status information associated with the UE 101. The status information can be retrieved from an equipment database 113. The status information can be retrieved based on the unique hardware identifier 115. As mentioned above, the unique hardware identifier 115 can include accessible identifiers such as an IMEI or difficult to access identifiers such as a serial number of a component associated with the UE 101. An IMEI number is accessible to users and other services. In certain embodiments, the difficult to access identifiers may be an identifier that requires a security key known to a manufacturer of the UE 101 to retrieve. The security information may be programmed into the activation application 107 to retrieve the identifier and send the identifier to the activation platform 103. This identifier may be more difficult for a person to steal or attempt to replicate. Status information can include whether the UE 101 has been blacklisted, information about the type of the UE 101, information about services available to the UE 101, licensing information, previous activation information, etc. As previously mentioned, the type of UE 101 can provide information about services available to the UE 101 and licensing rights of the UE 101. This information may be used to create an account associated with the UE 101.

Next, at step 305, a device type corresponding to the unique hardware identifier 115 is associated with licensing information to use the service. A particular device type may be associated with a license based on a packaged licensing agreement between the service provider and a manufacturer of the UE 101. The device type may be associated with a unique hardware identifier 115 in the equipment database 113. Licensing information may also be stored in the equipment database 113 or in another database. An example of a licensing agreement may include a license for using an unlimited amount of media (e.g., music) for a certain period of time. Different device types (e.g., models) may have different associated licenses. As different countries have different laws, a UE 101 of one device type activated in one country may have a different license associated with it in another country. The licensing information may be used to create a provisional account.

Further, at step 307, the runtime module 205 causes, at least in part, creation of a provisional account to activate the service based on the unique hardware identifier 115 without user information. The provisional account may be tied to the UE 101 via the unique hardware identifier 115. In some embodiments, the unique hardware identifier 115 may include more than one unique hardware identifier 115. For example, an IMEI number and a difficult to access identifier may be used in conjunction to form a unique hardware identifier 115. The unique hardware identifier 115 may be used to authenticate the UE 101 with the provisional account on a services platform 111 providing the service such as the media platform 109. Additional account settings can be associated with the provisional account, such as a status of the unique hardware identifier 115 (e.g., whether the unique hardware identifier 115 is valid, has previously been activated, etc.), a license associated with the UE 101 and provisional account, an activation country, service information (e.g., location of the service, type of service, etc.) and/or information (e.g., an activation code) that may be used to create a full account tied to a user of the UE 101. A full account may allow for portability of use of the service to other devices and user equipment.

Then, at step 309, the runtime module 205 generates an activation notification message. The notification message can include provisional account information describing the provisional account, including information such as an activation code that may be used to create a full account tied to a user of the UE 101. Moreover, the message may include license information and other information relating to the service. Next, at step 311, the runtime module 205 is causes transmission of the activation notification message to the UE 101.

The above approach, according to certain embodiments, allows for the activation of a service for a UE 101 with little additional effort needed by a user of the UE 101. This approach allows a UE 101 to connect to a service as soon as the UE 101 has access to a network. In this manner, a provisional account is created for the UE 101 allowing the UE 101 to access the service. Moreover, because the UE 101 can complete its portion of the activation process without the intensive manual input of information, the UE 101 can save battery life because manual input of information generally requires additional time for the UE 101 to be on (and an active display consumes significant power).

FIG. 4 is a flowchart of a process for completing activation of a service that has been provisionally activated, according to one embodiment. In one embodiment, an authentication module 119 of a services platform 111 performs the process 400 and is implemented in, for instance, a chip set including a processor and a memory as shown FIG. 9. In certain embodiments, the authentication module 119 is associated with a media platform 109.

At step 401, the authentication module 119 receives a request to use a service (e.g., media) from a UE 101 or other device. The authentication module 119 then, at step 403, initiates prompting for the UE 101 to provide account data. In certain scenarios, accounts are tied to UEs 101; in other scenarios, the accounts are tied to users. In the case of an account tied to a user (e.g., a full account) the user is able to authenticate using user information (e.g., a username and password). In the case of an account tied to a UE 101, provisional account data is received by the authentication module 119 (step 405). UE 101 provisional account data may include the unique hardware identifier 115, which can be used for authentication. In one example, the unique hardware identifier 115 can be transmitted via another device by attaching (e.g., via a universal serial bus (USB) connection) the device to the authorized UE 101. In another example, an activation code may be utilized to authenticate the user. The activation code may be received by a UE 101 when the UE 101 activates the service and receives an activation notification message from the activation confirming activation and creation of a provisional account. Then, the user is able to receive the services from the services platform 111. In certain scenarios, the user of the UE 101 is asked to create a full account associated with the user.

At step 407, the authentication module 119 requests and receives user information from the UE 101 or the device attached to the UE 101. The user information can include authentication information (e.g., a username and password), a user identifier (e.g., name information), contact information (e.g., phone number, address, e-mail, etc.), or the like. A full account can be created using another device (e.g., a personal computer). With the provisional account data and the user information, at step 409, the authentication module 119 can create a full account by merging the full account with the provisional account. For example, the provisional account can be converted to the full account by adding user information. Thus, full account data can be generated based on the provisional account data, which may include activation data associated with activating the provisional account and the user information. Moreover, the user information may include information about the use of the provisional account. For example, in a media platform 109, this use information may include the download history of the provisional account. This information may be used in providing the user customized services. For example, if the user already has downloaded the content, the user may have the right to download the content at a later time. In certain embodiments, the user is provided a license to download content for a set amount of time that expires. The user may be allowed access to the content as a right after the time period expires. The full account, now tied to the user and/or UE 101, may be used to access the service. In one exemplary scenario, the full account may be used to access the service on any UE 101 or device using a web application and authenticating. In another exemplary scenario, the full account may be used to access the service on a particular device (e.g., the full account is tied to the device and/or the UE 101).

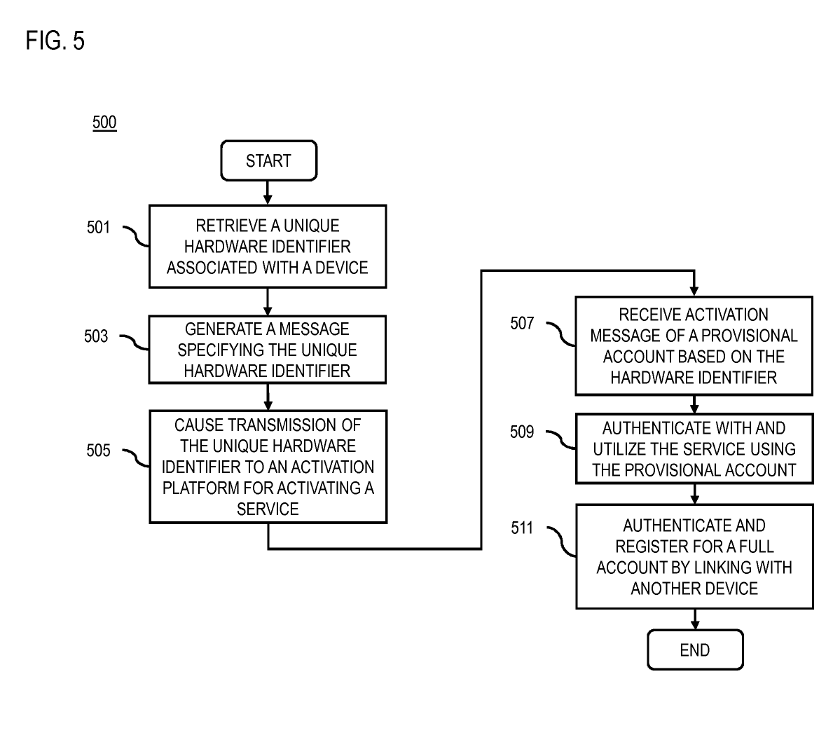

FIG. 5 is a flowchart of a process for initiating activation of a service tied to a user equipment, according to one embodiment. In one embodiment, the activation application 107 performs the process 500 and is implemented in, for instance, a chip set including a processor and a memory as shown FIG. 9. In certain embodiments, the UE 101 is a mobile device. The activation application 107 of the UE 101 may be initiated in response to an initialization of the UE 101. The initialization of a UE 101 may include an initial access of the UE 101 to a service provider (e.g., the insertion of a subscriber identity module (SIM)) or an initial registration of the UE 101 with the manufacturer such as after or during the acceptance of terms and conditions to utilize the UE 101. Initial registration may include the user agreeing to terms and conditions of using the UE 101 and/or confirming the country of residence of the user. Alternatively or additionally, the activation application 107 may be initiated in response to an initial attempt to use the service that is being activated.

At step 501, the activation application 107 retrieves a unique hardware identifier 115 associated with the UE 101 for activating a service for the UE 101. The activation application 107 may have access to the unique hardware identifier 115 because it is known to the operating system of the UE 101 (e.g., an IMEI). In certain embodiments, the unique hardware identifier 115 is difficult to access without a security key. The activation application 107 may also have access to the security key for the unique hardware identifier. This can occur because the manufacturer of the UE 101 may provide the security key for the activation application 107.

Then, at step 503, the activation application 107 generates a message specifying the unique hardware identifier 115. As noted previously, the unique hardware identifier 115 may include an IMEI, another unique identifier associated with a component of the UE 101, or a combination thereof. In certain embodiments, the message is an SMS message. Additionally, the message can be generated in response to the above mentioned initialization of the UE 101, which can initiate the activation application 107. The SMS message may also communicate the user's country, acceptance of terms and conditions, an MCC, an MNC, and/or an MSISDN. This information may be used by an activation platform 103 to determine service parameters associated with the UE 101.

Next, at step 505, the activation application 107 causes, at least in part, transmission of the mobile communication message for creating a provisional account to activate the service based on the unique hardware identifier 115 without user information. User information may be identifiers associated with the user that may be inputted by the user. This may include information about the user obtained via a query and input by the user. The provisional account may be created by the activation platform 103 or services platform 111 based on the message. The activation platform 103 may then send a notification activation message (e.g., an SMS message) that the provisional account has been created and provide information about the provisional account. Further, at step 507, the UE 101 receives the activation message of the creation of the provisional account based on the unique hardware identifier. At this point, the unique hardware identifier 115 may be used to authenticate with the service. Thus, the service may be tied to the UE 101. Moreover, the message may contain an activation code that can allow the user of the UE 101 to convert the provisional account to a full account. A full account may be tied to a user in addition to or as an alternative to the account being tied to the UE 101.

Moreover, at step 509, the activation application 107 or a service application 107 such as a media application 107 on the UE 101 may be used to authenticate with and utilize the service using the provisional account. To utilize the provisional account, the service application 107 can authenticate using the unique hardware identifier 115. In certain scenarios, when the service application 107 utilizes the UE 101, the user may be prompted to activate a full account by providing user information.

Then, at step 511, the service application 107 authenticates and registers for a full account. The UE 101 may be linked with another device to cause the activation process. The link may be via a wireless interface such as a BLUETOOTH interface or via a wired link such as a USB interface. The UE 101 may be used as a key to allow access to the provisional account to the other device. Alternatively or additionally, the user may use an activation code received via the notification message to access the provisional account. The user may then be prompted to input user information, which the user can input into the other device or UE 101. Moreover, the service application 107 may send the user information to the services platform 111 to create a full account based on the provisional account. The user information may include authentication information that allows the user to utilize the full account from one or more other user equipment other than the UE 101 (e.g., the other device).

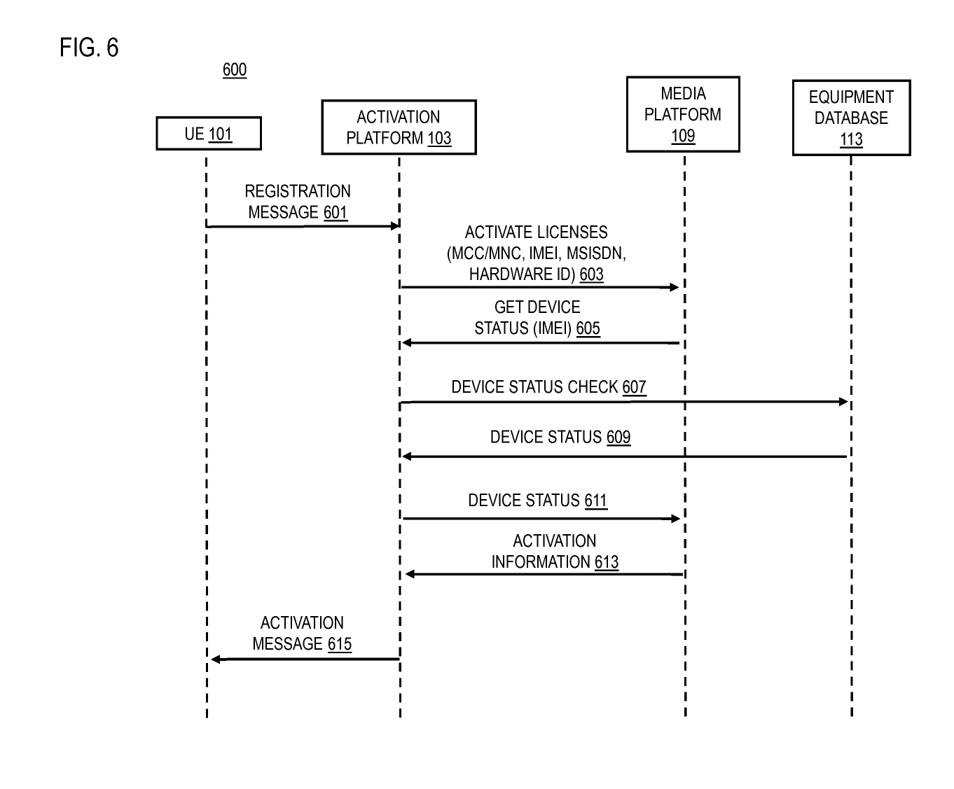

FIG. 6 is a ladder diagram 600 presenting processes for conveniently activating a media service by a user, according to one embodiment. By way of example, this process is described with respect to the system 100 of FIG. 1. As described above, the UE 101 may send a registration message 601, such as an SMS, to register the UE 101 and activate a media service associated with the UE 101 to the activation platform 103. A runtime module 205 of the activation platform 103 may then examine the SMS and extract components of the message into usable information. Such extracted components can include the MCC, MNC, IMEI, MSISDN, and hardware identifier 115 associated with the UE 101. This information may be caused to be transmitted 603 to the media platform 109 along with a request to activate a license for the UE 101 to create a provisional account for the UE 101. In response to the request, the media platform 109 may request that the activation platform 103 inform the media platform 109 of the status of the UE 101 based on the hardware identifier 115 (e.g., the IMEI) (step 605). The activation platform 103 then queries (step 607) the equipment database 113 for information about the UE 101 based on the hardware identifier 115. The equipment database 113 can store information about UEs 101 as detailed above including hardware identifiers 115, blacklist status, and licensing information. The equipment database 113 then returns the device status (step 609) to the activation platform 103. The activation platform 103 may then forward (step 611) the device status to the media platform 109 to activate the provisional account for the UE 101.

The media platform 109 then creates a provisional account for the UE 101 based on the device status. The device status may include whether the UE 101 has already been activated, whether the UE 101 has been blacklisted, and/or a type of license that is available to the UE 101 to create the provisional account. Further, the provisional account may be set to begin a time period where the license and/or provisional account expires at the end of the time period or set time. Additionally, the media platform 109 may determine from the licensing information whether the UE 101 license can be extended to use on one or more other devices. Under one scenario, this license determination can be stored as a portion of provisional account data. In another scenario, the license determination can be used to generate an activation code. This activation code can be part of activation information that is transmitted (step 613) to the activation platform 103. Moreover, the activation information may include the status of the UE 101 (e.g., whether the media service is currently active, the media service was previously activated, the country of activation, licensing information, etc.) as well as the activation code. Additionally the activation information can include error message identifiers if the UE 101 was blacklisted, if no license was found, or there was another fault. The activation platform 103 may then forward the activation information to the UE 101 using an activation message at step 615. The activation message may be communicated as an SMS or other telephony message to the UE 101. The UE 101 can then display the activation message and, upon successful activation, may begin using the media service.

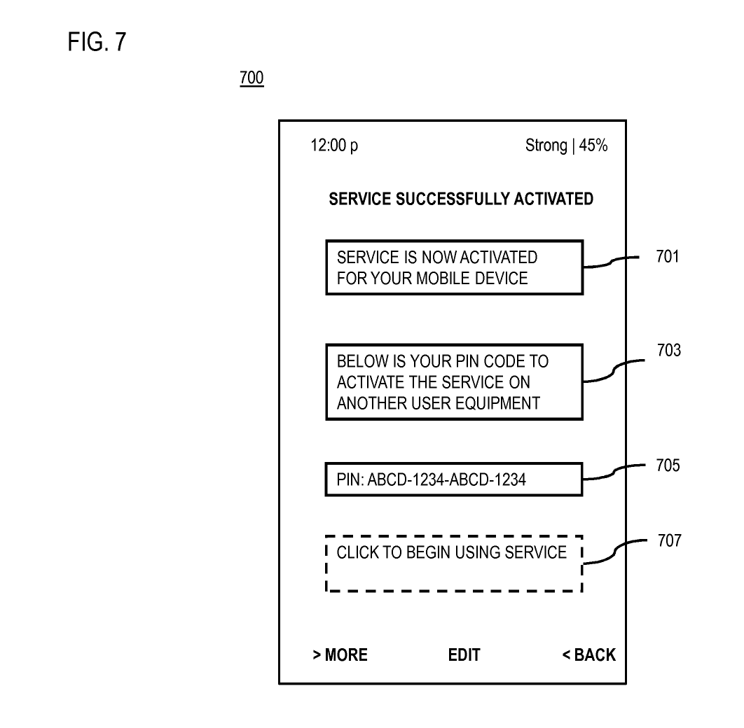

FIG. 7 is a diagram of a user interface 700 utilized in the processes of FIGS. 3-6, according to various embodiments. The user interface 700 can include various methods of presentation and input. For example, the user interface 700 can have outputs including a visual component (e.g., a screen), an audio component, and a physical component (e.g., vibrations), etc. User inputs can include a touch-screen interface, a scroll-and-click interface, a button interface, a microphone, etc. The user interface 700 displays information during the activation of a service for the UE 101. A successful activation message 701 can be displayed indicating that the UE 101 service has been successfully activated. Successful activation can include the creation of a provisional account associated with the UE 101. Additionally, a full account creation message 703 can be presented to the user indicating that an activation code 705 can be used to activate the service on another user equipment (e.g., a personal computer). Moreover, the user interface 700 may include an option 707 to begin using the service once the activation process has successfully completed. Once the activation process has been completed, the user can authenticate with the service by using the UE 101. The UE 101 can send the hardware identifier 115 to login to the service.

The processes described herein for providing provisional activation of a service tied to a user equipment may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

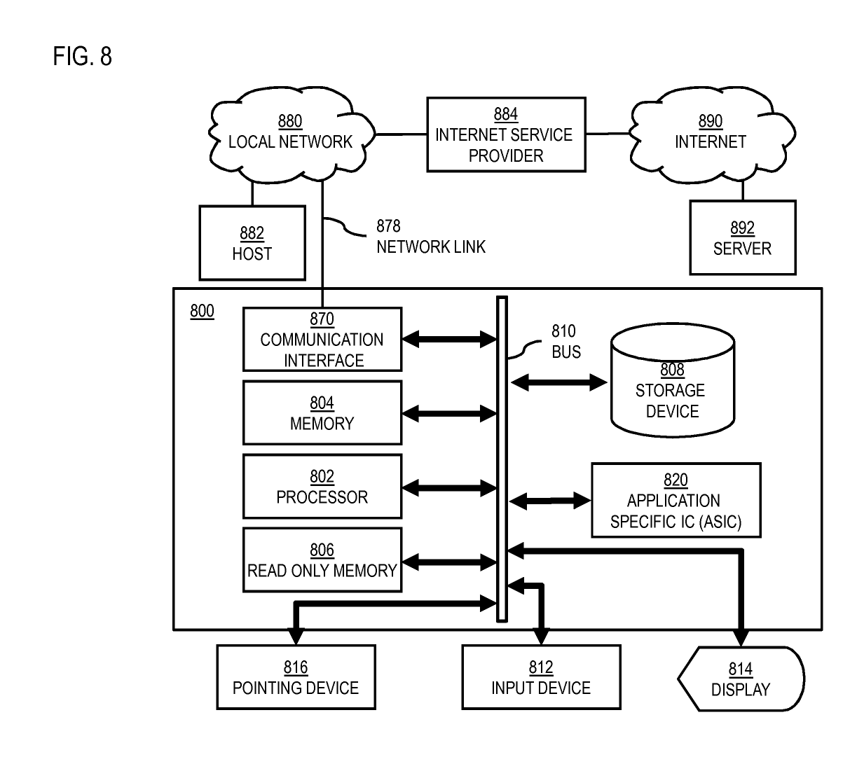

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provisional activation of a service tied to a user equipment as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of provisionally activating a service tied to a user equipment.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to provisional activation of a service tied to a user equipment. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing provisional activation of a service tied to a user equipment. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for provisional activation of a service tied to a user equipment, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing activation services to the UE 101.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to provide provisional activation of a service tied to a user equipment as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of providing provisional activation of a service tied to a user equipment.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide provisional activation of a service tied to a user equipment. The memory 905 also stores the data associated with or generated by the execution of the inventive steps.

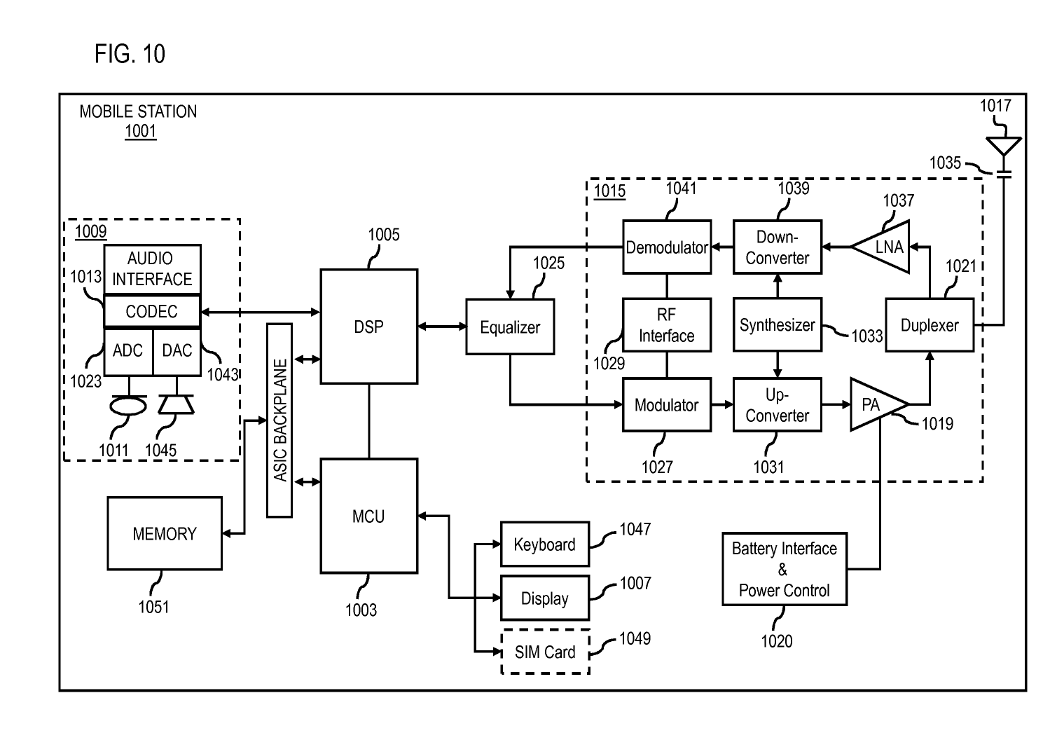

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of requesting provisional activation of a service. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of requesting provisional activation of a service. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to request provisional activation of a service. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a message from a mobile device specifying a unique hardware identifier associated with the mobile device for activating a service for the mobile device; and
causing, at least in part, creation of a provisional account to activate the service based on the unique hardware identifier without user information.

2. A method of claim 1, wherein the unique hardware identifier comprises either an international mobile equipment identity, an identifier associated with an electronic component of the mobile device, or a combination thereof.

3. A method of claim 1, further comprising:
associating a device type corresponding to the unique hardware identifier with licensing information to use the service; and
causing, at least in part, transmission of provisional account data associated with the provisional account to the mobile device.

4. A method of claim 1, wherein the provisional account data includes activation data to convert the provisional account into a full account, the method further comprising:
receiving another message specifying the activation data and user information;
generating full account data based on the activation data and the user information; and
storing the full account data.

5. A method of claim 1, wherein the message is a short messaging service message.

6. An apparatus comprising:
at least one processor; and
at least one memory including computer program code,
the at least one memory and the computer program code configured to, with the at least one processor, cause the apparatus to perform at least the following,
receive a message from a mobile device specifying a unique hardware identifier associated with the mobile device for activating a service for the mobile device; and
cause, at least in part, creation of a provisional account to activate the service based on the unique hardware identifier without user information.

7. An apparatus of claim 6, wherein the unique hardware identifier comprises either an international mobile equipment identity, an identifier associated with an electronic component of the mobile device, or a combination thereof.

8. An apparatus of claim 6, wherein the apparatus is further caused, at least in part, to:
associate a device type corresponding to the unique hardware identifier with licensing information to use the service; and
cause, at least in part, transmission of provisional account data associated with the provisional account to the mobile device.

9. An apparatus of claim 6, wherein the provisional account includes activation data to convert the provisional account into a full account, and the apparatus is further caused, at least in part, to:
receive another message specifying the activation data and user information;
generate full account data based on the activation data and the user information; and
store the full account data.

10. An apparatus of claim 6, wherein the message is a short messaging service message.

11. A method comprising:
retrieving a unique hardware identifier for activating a service for a mobile device;
generating a message specifying the unique hardware identifier; and
causing, at least in part, transmission of the mobile communication message for creating a provisional account to activate the service based on the unique hardware identifier without user information.

12. A method of claim 11, wherein the unique hardware identifier comprises an international mobile equipment identity, an identifier associated with an electronic component of the mobile device, or a combination thereof.

13. A method of claim 11, further comprising:
receiving an activation notification from the service; and
causing, at least in part, authenticating with the service by specifying the unique hardware identifier in response to the activation notification.

14. A method of claim 13, wherein the activation notification specifies that a provisional account has been created, the method further comprising:
causing, at least in part, a link with a device; and
causing, at least in part, authenticating with the service via the device to create a full account.

15. A method of claim 11, wherein the generating of the message is in response to an initialization of the mobile device and the message is a short messing service message.

16. An apparatus comprising:
at least one processor; and
at least one memory including computer program code,
the at least one memory and the computer program code configured to, with the at least one processor, cause the apparatus to perform at least the following,
retrieve a unique hardware identifier for activating a service for a mobile device;
generate a message specifying the unique hardware identifier; and
cause, at least in part, transmission of the mobile communication message for creating a provisional account to activate the service based on the unique hardware identifier without user information.

17. An apparatus of claim 16, wherein the unique hardware identifier comprises an international mobile equipment identity, an identifier associated with an electronic component of the mobile device, or a combination thereof.

18. An apparatus of claim 16, wherein the apparatus is further caused, at least in part, to:
receive an activation notification from the service; and
cause, at least in part, authenticating with the service by specifying the unique hardware identifier in response to the activation notification.

19. An apparatus of claim 18, wherein the activation notification specifies that a provisional account has been created and the apparatus is further caused, at least in part, to:
cause, at least in part, a link with a device; and
cause, at least in part, authenticating with the service via the device to create a full account.

20. An apparatus of claim 16, wherein the generating of the message is in response to an initialization of the mobile device and the message is a short messaging service message.
